(19) United States
(12) Patent Application Publication
(10) Pub. No.: US 2008/0041524 A1
(43) Pub. Date: Feb. 21, 2008

(54) ADHESIVE TAPE DEVICE

(76) Inventor: Dillon P. McCarthy, Denver, CO (US)

Correspondence Address: SHERIDAN ROSS PC, 1560 BROADWAY, SUITE 1200, DENVER, CO, 80202, US

(21) Appl. No.: 11/923,264

(22) Filed: Oct. 24, 2007

Related U.S. Application Data
(63) Continuation-in-part of application No. 11/181,296, filed on Jul. 14, 2005, now abandoned.

(51) Int. Cl. B32B 38/10; B32B 33/00

(52) U.S. Cl. 156/344; 428/41.3; 428/41.5; 428/41.8

(57) ABSTRACT

Disclosed is an adhesive tape device for relatively effortless, quick, easy, and effective manual separation of the adhesive-coated surface from the underlying non-adhesive surface of the tape roll, and eliminating the necessity for tape-dispensing apparatuses. It comprises an adhesive element having a stack of layers with longitudinal and latitudinal ends and includes at least a backing layer having a first side and a second side, an adhesive layer affixed upon the second side, at least a non-adhesive, impermanent discardable element with longitudinal and latitudinal edges configuring a width and length thereof and affixed at least partially on the latitudinal ends of the second side of the backing layer, a plurality of lines of perforations arranged across said width of non-adhesive, impermanent discardable element and extending partially into the adhesive element across the latitudinal ends thereby configuring an easy tearable and peelable adhesive tape device thereof.

### CROSS REFERENCE TO RELATED APPLICATION

The present application is a continuation-in-part of U.S. patent application Ser. No. 11/181,296, filed Jul. 14, 2005, entitled “Adhesive Tape Device”; which is incorporated herein by this reference.

### FIELD OF THE INVENTION

The present invention relates generally to adhesive tapes, and more particularly to an adhesive tape device which provides an effortless, quick, easy, and effective method for manually separating and severing sections from the tape roll and eliminates the necessity for tape-dispensing apparatuses.

### BACKGROUND OF THE INVENTION

Since the innovative engineer of 3M (Minnesota Mining and Manufacturing) Company, Richard G. Drew (1886-1956), invented masking tape and clear adhesive tape (also called cellophane tape or scotch tape), there has been a large amount of activity in the general field of adhesive tape. The prior arts in the field disclose numerous different techniques for adhesive tapes. A general description of useful pressure-sensitive adhesives can be found in the Encyclopedia of Polymer Science and Engineering, Volume 13, Wiley-Interscience Publishers (New York, 1988). An additional description of useful pressure-sensitive adhesives may be found in the Encyclopedia of Polymer Science and Technology, Vol. 1, Interscience Publishers (New York, 1964). Many such techniques of adhesive tapes are too complex for reliable operation and are incapable of working properly. Therefore, there has been an immense frustration with the difficulty the consumer has in separating the adhesive-coated surface from the underlying non-adhesive surface of the roll of tape. However, at the present time in the commercial market, no such adhesive tape and technique is available which is capable of separating the tape from the roll of tape with ease and comfort.

Subsequent to the creation of masking tape and clear adhesive tape was the incorporation of a non-adhesive pull-tab element, which is affixed to the origin of separation, allowing an initial separation of tape from the roll to be made. Although this addition is useful to a degree, once the initial separation of the tape has been made and the pull-tab element has been severed from the roll, the tape either needs to be folded over or placed on an accessible region of a tape-dispensing apparatus for instantaneous and unconstrained future use.

A number of solutions to this problem have emerged over time, but the most socially preferred solution was the tape-dispensing apparatus, which was first created in 1932 by John A. Borden and has a built-in cutting accessory. In addition to its cutting accessory, these tape dispensers feature a tape grip, designed to allow tape to be guided through to the cutting element and to hold the remaining peeled-up portion for future use. Unfortunately, all designs to-date are frustratingly inadequate. The tape still slips from the tape-grip and clings back to the roll. Granted, this provided an adequate solution to the problem of severing sections of tape from the roll, the development of these devices has lead to another unforeseen dilemma. A tape-dispensing apparatus or another cutting device has now become a necessity for a multitude of adhesive tapes to be manually severed from the roll.

In following years, technical progress has resulted in the production of adhesive tapes, which had been developed originally for sealing shipping parcels and storage boxes. This pressure-sensitive adhesive tape has become widely known as packaging tape. In 1997, 3M introduced Scotch tear-by-hand packaging tape. This tape does not proffer a solution to a handful of other problems. First of all, a tear-by-hand function has not been fabricated into a number of other tapes including various packaging tapes, which have their own unique design and composition. Secondly, 3M Scotch tear-by-hand packaging tape is as equally difficult to peel from the roll as the alternative packaging tapes. Furthermore, the final problem associated with 3M Scotch tear-by-hand packaging tape is the waste and dissipation resulting from tape tearing improperly.

U.S. Patent Publication No. 20030031863 discloses an adhesive tape device comprising an adhesive tape pre-wound on a reel and able to be rotated while mounted on a tape holder about an axis and an anvil transversely formed on a front portion of the tape holder beneath the tape. The adhesive tape has two opposite side edge portions across a width of the tape, each side edge portion being projectively perpendicular to the axis. The adhesive tape also includes a plurality of short cutting slits which are equally-spaced and pre-cut in one side edge portion that is lengthwise of the tape, and each short-cutting slit defines an acute angle as deviated from one side edge portion which is measured from a pulling direction distal from the axis of the reel when outwardly pulling or tearing the tape from the reel. This device involves complex design, and its bulky structural indices are too complex for reliable operation and proper working.

U.S. Pat. No. 5,861,077 provides an adhesive tape which comprises a base sheet, an adhesive sheet that is applied to the base sheet, and a backing sheet laminated to the base sheet. According to the invention, one end of the adhesive tape is supported, leaving that end as a free end. A separation means bends a free end in the direction from a first surface of the adhesive tape to a second surface of the adhesive tape until slippage occurs between the adhesive sheet and backing sheet. This device is also too complex for reliable operation and is incapable of working properly. The complex design and bulky structural indices hinders the performance of this device. It does not provide any effective means wherein the tape can be manually separated and severed from the roll with ease and comfort.

The U.S. Pat. No. 5,763,038, discloses a tape which includes a backing layer and an adhesive layer formed on the backing layer. A plurality of lines of perforations extends across the tape to separate the tape into sheets. The sheets have progressively increasing lengths such that, when the sheets are wound into a roll, each sheet is longer than the sheet underneath it. When in a roll, the outermost sheet covers all of the lines of perforations to reduce instances of the tape tearing in a down-web direction. This device is also complex for reliable operation and is incapable of working properly. It does not provide any method wherein the tape can be manually separated from the roll with ease and comfort, leading to the tape being inadequate to address the needs of the user.

Although, the aforecited prior art, since their inception, had successfully met their requisite objectives, the passage of time has revealed the inherent drawbacks in the said prior arts and not only rendered the said prior arts as obsolete but also affected their effectiveness in the sense that their complex design and bulky structural indices hinders their performance. Therefore, as with any product over time, it becomes apparent that there is always room for improvement which necessitates the need for a new device that incorporates within it simple structural indices, portability, and reliability in operation.

Therefore, the present scenario is punctuated by an emerging need for an adhesive tape and technique which is capable of separating the tape manually from the roll of tape (i.e. separating adhesive-coated surface from the underlying non-adhesive surface of the roll or tape) with ease and comfort.

### SUMMARY OF THE INVENTION

In view of the foregoing disadvantages inherent in the above-mentioned prior arts, the general purpose of the present invention is to provide an improved combination of convenience and utility, to include all the advantages of the prior arts, and to overcome the above-mentioned disadvantages or drawbacks of the prior arts.

It is therefore a principal aspect of the present invention to provide an improved, simplified, economical, portable, and useful adhesive tape device which can be mass produced inexpensively and can provide means to a relatively effortless, quick, easy, and effective method for manual separation of the adhesive-coated surface from the underlying non-adhesive surface of the tape roll. Also, a goal of the invention is to eliminate the necessity for a tape-dispensing apparatus or other various cutting instruments to manually sever sections of tape from the roll.

In one aspect of the present invention, an adhesive tape device comprises at least a non-adhesive, impermanent discardable element with longitudinal and latitudinal ends configuring a width and length thereof, affixed at least partially on latitudinal ends of an adhesive element. Furthermore, the non-adhesive, impermanent discardable element has a plurality of lines of perforations arranged across the width and extending partially into the adhesive element, enabling relatively effortless, quick, easy, and effective tearing and peeling of the adhesive tape.

In another aspect of the present invention, an adhesive tape device comprises an adhesive element having a stack of layers with longitudinal and latitudinal ends, the stack including a backing layer having a first side and a second side, an adhesive layer affixed thereupon the second side of the backing layer, and a non-adhesive, impermanent discardable element with longitudinal and latitudinal edges which configure a width and length thereof. The non-adhesive, impermanent discardable element is affixed at least partially on the latitudinal ends of the second side of the backing layer of the adhesive element. A plurality of lines of perforations are arranged across the width of the non-adhesive, impermanent discardable element and extend partially into the adhesive element across the latitudinal ends thereby configuring a relatively effortless, quick, easy, and effective tearable and peelable adhesive tape device. The adhesive tape device is able to be formed into a roll that has a plurality of wraps with the adhesive layer of the adhesive element facing inward by rolling the adhesive tape device onto itself. The adhesive element of the adhesive tape device may also contain antistatic materials, and the backing layer may be modified by flame treatment, corona treatment, and roughening.

In another aspect, the present invention provides for an adhesive tape device wherein the first and second side of the backing layer may be made up of paper, plastic film, or the like, and the paper backings may include saturated flatstock, crepe, or the like. The plastic film may include polypropylene, polyethylene, copolymers of polypropylene and polyethylene, polyesters, and vinyl acetate. The polypropylene can be biaxially-oriented polypropylene (BOPP) or simultaneously biaxially-oriented polypropylene (SBOPP). The backing layer may be compost-able, degradable, colored, printed, embossed, and may be of different surface textures. The printed material may be located either on the first side or on the second side of the backing layer before affixation of the adhesive layer and may include advertising, instructions, or other information.

In another aspect, the present invention provides for an adhesive tape device wherein the adhesive layer may be affixed to the second side of the backing layer in a multitude of various layouts and patterns. The affixation of the adhesive layer to the second side of the backing layer may include adhesive coating covering the entire second side of the backing layer, may include adhesive coating only along each of the latitudinal and longitudinal ends of the second side of the backing layer, and may also include diagonal, horizontal, or criss-cross adhesive coated patterns on the second side of the backing layer. The adhesive for affixation of said adhesive layer to the second side of the backing layer may include hotmelt-coated formulations, transfer-coated formulations, solvent-coated formulations, latex formulations, or all pressure-sensitive adhesives. Also, the adhesives may be based on general compositions of polyacrylate; polyvinyl ether; diene-containing rubber such as natural rubber, polyisoprene, and polyisobutylene; polychloroprene; butyl rubber; butadieneacrylonitrile polymer; thermoplastic elastomer; block copolymers such as styrene-isoprene and styrene-isoprene-styrene block copolymers, ethylene-propylene-diene polymers, and styrene-butadiene polymer; poly-alpha-olefin; amorphous polyolefin; silicone; ethylene-containing copolymer such as ethylene vinyl acetate, ethylacrylate, and ethyl methacrylate; polyurethane: polyamide; epoxy; polyvinylpyrrolidone and vinylpyrrolidone copolymers; polyesters; and mixtures of the above. The adhesives may also contain additives such as tackifiers, plasticizers, fillers, antioxidants, stabilizers, pigments, diffusing particles, curatives, and solvents.

In yet another aspect, the present invention provides for an adhesive tape device wherein the non-adhesive, impermanent discardable elements may be made up of suitable plastics including polypropylene, polyethylene, copolymers of polypropylene and polyethylene, polymers, polyesters, and vinyl acetates. The polypropylene may be biaxially-oriented polypropylene (BOPP) or simultaneously biaxially-oriented polypropylene (SBOPP). The non-adhesive, impermanent discardable element may be compost-able, degradable, colored, printed, embossed, and may be of different surface textures. The printed material may be fabricated onto either or both of the non-adhesive, impermanent discardable elements. Furthermore, the printed material can be advertising, instructions, or other information. The non-adhesive, impermanent discardable element may contain antistatic agents and may also be modified by flame treatment, corona treatment, and roughening.

In another aspect of the present invention, the non-adhesive, impermanent discardable element may be affixed onto the second surface of the adhesive layer using a releasable non-stick agent, waxes, lacquers, or other similar chemical solutions. The plurality of lines of apertures may be of any shape and angle, and any distance between each of the adjacent arrangements of apertures may be used.

In another aspect, the present invention provides for a method for relatively effortless, quick, easy, and effective tearing and peeling of the adhesive tape from an adhesive roll; the method comprises configuring an adhesive element which has a stack of layers with longitudinal and latitudinal ends. The stack includes a backing layer having a first side and a second side and an adhesive layer affixed thereupon the second side of the backing layer, configuring a non-adhesive, impermanent discardable element with longitudinal and latitudinal edges forming a width and length thereof. The non-adhesive, impermanent discardable element is affixed at least partially on the latitudinal ends of the second side of the backing layer of the adhesive element, configuring a plurality of lines of perforations arranged across the width of the non-adhesive, impermanent discardable element and extending partially into the adhesive element across the latitudinal ends, holding the non-adhesive, impermanent discardable element and peeling off from the adhesive roll to a desired length, tearing off the pealed adhesive tape at the lines of perforations enabling an easy and effective tearing off of the adhesive tape device, and peeling off the non-adhesive, impermanent discardable element and sticking to a desired surface.

These together with other aspects of the present invention, along with the various features of novelty that characterize the invention, are pointed out with particularity in the claims annexed hereto which form a part of this disclosure. For a better understanding of the invention, its operating advantages, and the specific objects attained by its uses, reference should be taken to the accompanying drawings and descriptive matter in which there are illustrated exemplary embodiments of the invention.

### BRIEF DESCRIPTION OF THE DRAWINGS

The advantages and features of the present invention will be better understood with reference to the following more-detailed description and claims taken in conjunction with the accompanying drawings, in which like elements are identified with like symbols, and in which:

FIG. 1 is a magnified, front, top view of an adhesive tape, in accordance with the present invention;

FIG. 2 is a top view of an adhesive tape with the non-adhesive, impermanent discardable elements shown separated from the adhesive element, in accordance with the present invention.

FIG. 3 is a top view of an adhesive tape with a severed section of tape from the roll, in accordance with the present invention;

FIG. 4 is a perspective view of an adhesive tape device wound on a roll, in accordance with the present invention;

FIG. 5 is a magnified, front, top view of an adhesive tape, in accordance with the present invention.

FIG. 6A is a magnified, front, top view with hidden lines of an adhesive tape, in accordance with the present invention.

FIG. 6B is a magnified, front view of FIG. 6A.

FIG. 7A is a magnified, front, top view of an adhesive tape, in accordance with the present invention.

FIG. 7B is a detailed view of a portion of FIG. 7A.

FIG. 8 is a bottom view of an adhesive tape with the non-adhesive, impermanent, discardable element shown separated from the adhesive element, in accordance with the present invention.

Like reference numerals refer to like parts throughout the several views of the drawings.

### DESCRIPTION OF THE PREFERRED EMBODIMENT

The exemplary embodiments described herein detailed for illustrative purposes are subject to many variations in structure and design. It should be emphasized, however, that the present invention is not limited to a particular adhesive tape device as shown and described. Rather, the principles of the present invention can be used with a variety of adhesive tape device configurations and structural arrangements. It is understood that various omissions and substitutions of equivalents are contemplated as circumstances may suggest or render expedient, but it is intended to cover the application or implementation without departing from the spirit or scope of the claims of the present invention.

The present invention provides an adhesive tape device for a relatively effortless method for manual separation of the adhesive-coated surface from the underlying non-adhesive surface of the roll of tape, and also eliminates the necessity for a tape-dispensing apparatus or other various cutting instruments to manually sever sections of tape from the roll, addresses the work requirement, and may be made available in low cost materials. Thus, the invention would serve the commercial viability of a cost-effective adhesive tape device, which would eliminate the need for an additional dispensing apparatus and overcome all the existing drawbacks.

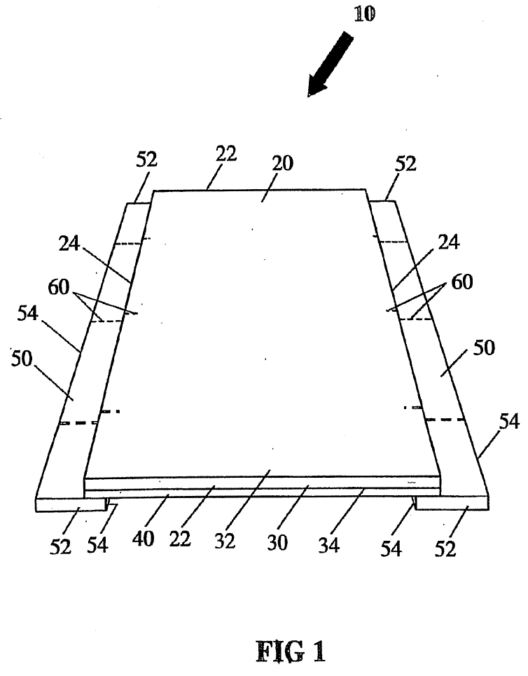

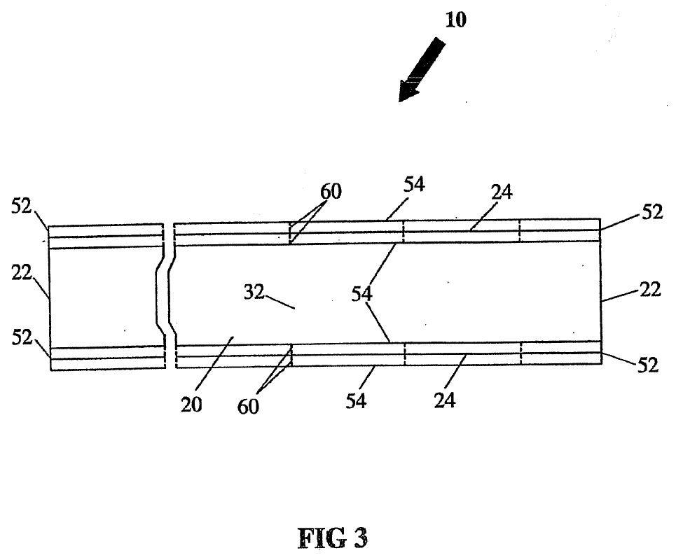

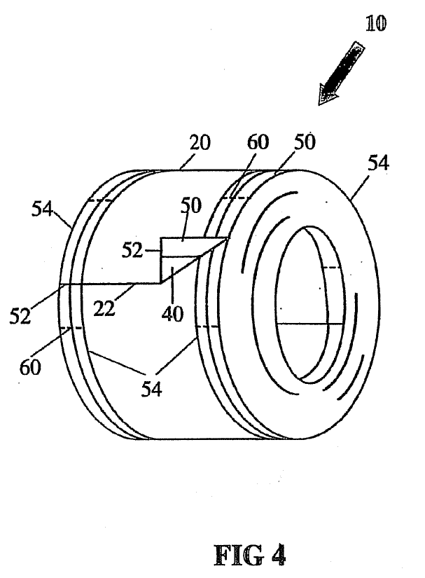

FIGS. 1-4 shows the various views of an adhesive tape device 10 comprising an adhesive element 20 having a stack of layers with longitudinal and latitudinal ends 22, 24. The stack of layers includes at least a backing layer 30 having a first side 32 and a second side 34, and an adhesive layer 40 affixed thereupon the second side 34 of the backing layer 30. The adhesive tape device 10 also comprises at least a non-adhesive, impermanent discardable element 50 with longitudinal and latitudinal edges 52, 54 and configures a width and length thereof, and the non-adhesive, impermanent discardable element 50 is affixed at least partially on the latitudinal ends 24 of the second side 34 of the backing layer 30 of the adhesive element 20 extending along the entire roll, parallel to the latitudinal ends 24. A plurality of lines of perforations 60 are arranged across the width of the non-adhesive, impermanent discardable element 50 and extending partially into the adhesive element 20 across the latitudinal ends 24 and thereby configures an easy tearable and peelable adhesive tape device 10 thereof.

The lines of perforations can be set in any angular direction, more specifically shown perpendicular to the latitudinal ends 24 of the second side 34 of the backing layer 30 and across the entire width of each of the non-adhesive, impermanent discardable elements 50, extending partially into the adhesive element 20 across the latitudinal ends 24 in which case, each of the arrangements of lines of perforations 60 slightly overlap the latitudinal ends 24 of the adhesive element 20. These arrangements of lines of perforations 60 facilitate severing of the adhesive tape device 10 of any desirable length from the roll.

As shown in FIGS. 1-3, the adhesive element 20 has longitudinal ends 22 and latitudinal ends 24. As shown in FIG. 1, the tape is formed of at least two layers, a backing layer 30 and an adhesive layer 40 and can be made from any known materials. The adhesive tape device 10 is formable into a roll having a plurality of wraps.

The backing layer 30 has a first side 32 and a second side 34 and can be made of, for example, paper or plastic film. Suitable paper backings could include, but are not limited to, saturated flatstock and crepe. Suitable plastic film backings could include, but are not limited to, polypropylene, polyethylene, copolymers of polypropylene and polyethylene, polyesters, and vinyl acetate. The polypropylene can be biaxially-oriented polypropylene (BOPP) or simultaneously biaxially-oriented polypropylene (SBOPP). The backing material can be compost-able, degradable, colored, printed, and can be of different surface textures or embossed.

The adhesive layer 40 may be placed on the second side 34 of the backing layer 30 in a multitude of various layouts and patterns, including but not limited to; adhesive coating covering the entire area of the second side 34 of the backing layer 30, uncoated along the center with the adhesive coating along each side edge of the second side 34 of the backing layer 30, adhesive coating along one side edge of the second side 34 of the backing layer 30, and diagonal, horizontal, or criss-cross adhesive coated patterns on the second side 34 of the backing layer 30.

The adhesive, for example, can include hotmelt-coated formulations, transfer-coated formulations, solvent-coated formulations, and latex formulations. Useful adhesives according to the present invention include all pressure-sensitive adhesives. Pressure-sensitive adhesives are normally tacky at room temperature and can be adhered to a surface by application of, at most, light finger pressure. Examples of adhesives useful in the invention include those based on general compositions of polyacrylate; polyvinyl ether; diene-containing rubber such as natural rubber, polyisoprene, and polyisobutylene; polychloroprene; butyl rubber; butadieneacrylonitrile polymer; thermoplastic elastomer; block copolymers such as styrene-isoprene and styrene-isoprene-styrene block copolymers, ethylene-propylene-diene polymers, and styrene-butadiene polymer; poly-alpha-olefin; amorphous polyolefin; silicone; ethylene-containing copolymer such as ethylene vinyl acetate, ethylacrylate, and ethyl methacrylate; polyurethane: polyamide; epoxy; polyvinylpyrrolidone and vinylpyrrolidone copolymers; polyesters; and mixtures of the above. Additionally, the adhesives can contain additives such as tackifiers, plasticizers, fillers, antioxidants, stabilizers, pigments, diffusing particles, curatives, and solvents.

The adhesive tape device 10 is formed into a roll having a plurality of wraps with the adhesive layer 40 facing inward by rolling the adhesive tape onto itself. Support material, such as a core, a liner, or any other material that could lend support and provide rigidity and strength to the roll of tape, is optional. In the illustrated embodiments, none is used.

Numerous other layers can be added to the adhesive tape device 10, such as primers, to increase the adhesion of the adhesive layer 40 to the second side 34 of the backing layer 30. Also, printed material can be located on the first side 32 of the backing layer 30, or on the second side 34 before the adhesive layer 40. This printed material can be advertising, instructions, or other information. The adhesive element 20 could contain antistatic materials, and the backing layer 30 could be modified by flame treatment, corona treatment, and roughening.

As further shown in FIGS. 1-4, there are two non-adhesive, impermanent discardable elements 50, which are affixed to the latitudinal ends 24 of the adhesive element 20. Although, there are other variations to the design of the present invention, the detailed description is in reference of the figures provided. Other variations include but are not limited to, one non-adhesive, impermanent discardable element 50, which is affixed partially to one latitudinal end 24 of the adhesive layer 40 of the adhesive element 20, comprising of multiple arrangements of lines of perforations 60 for manually tear-able sections of tape from the roll; or two non-adhesive, impermanent discardable elements 50 which are affixed partially to each latitudinal ends 24 of adhesive element 20, one of which comprises of multiple arrangements of lines of perforations 60 for manually tear-able sections of tape from the roll.

Further shown in FIGS. 1-4, there are two non-adhesive, impermanent discardable elements 50, which each have longitudinal ends 52 and latitudinal ends 54. These non-adhesive, impermanent discardable elements 50 can be made from any known material, including but not limited to, paper or plastic. Suitable plastics used for the non-adhesive, impermanent discardable elements 50 could include but are not limited to, polypropylene, polyethylene, copolymers of polypropylene and polyethylene, polymers, polyesters, and vinyl acetates. The polypropylene can be biaxially-oriented polypropylene (BOPP) or simultaneously biaxially-oriented polypropylene (SBOPP). The non-adhesive, impermanent discardable elements 50 can be compost-able, degradable, colored, printed, and can be of different surface textures or embossed. Printed material could also be fabricated onto either or both of the non-adhesive, impermanent discardable elements 50. This printed material can be advertising, instructions, or other information. The non-adhesive, impermanent discardable elements 50 could contain antistatic agents and could also be modified by flame treatment, corona treatment, and roughening.

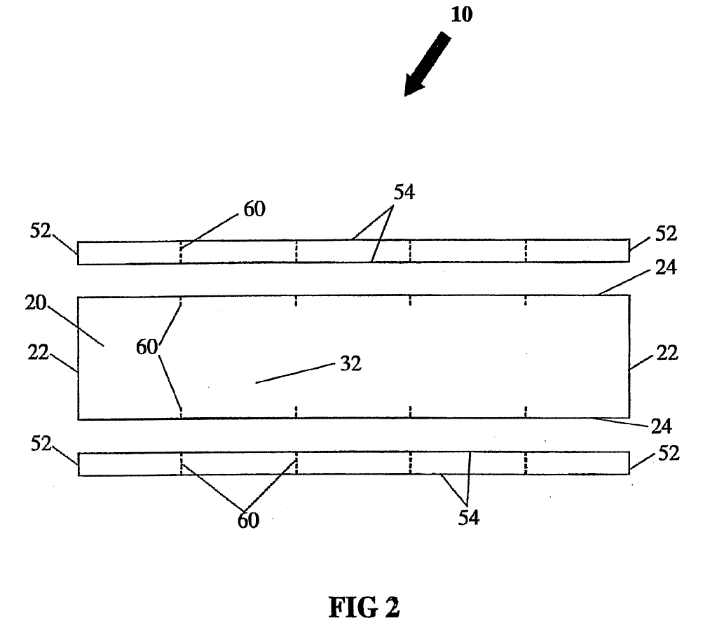

As shown in FIGS. 1-3, the non-adhesive, impermanent discardable elements 50 are partially affixed to each latitudinal ends 24 of the adhesive layer 40 of the adhesive element 20 along the entirety of the roll. These non-adhesive, impermanent discardable elements 50 provide a relatively effortless method for separating the overlapping adhesive layer 40 from the underlying backing layer 30 of the adhesive element 20. The portion of the non-adhesive, impermanent discardable elements 50 that are affixed to the adhesive layer 40 of the adhesive element 20, may be affixed using a releasable non-stick agent or layer between each of the non-adhesive, impermanent discardable elements 50 and the adhesive layer 40 of the adhesive element 20 by using, for example, waxes, lacquers, or other chemical solutions. This would provide a relatively effortless method for peeling the non-adhesive, impermanent discardable elements 50 from the adhesive layer 40 of the adhesive element 20. As shown in FIG. 2, the non-adhesive, impermanent discardable elements 50 are separated from the adhesive element 20. This releasable non-stick agent or layer would leave the latitudinal ends 24 of the adhesive layer 40 that was affixed to the non-adhesive, impermanent, and discardable element 50 unimpaired. Therefore, the entire adhesive layer 40 of the adhesive element 20 may be applied to any desirable surface without having free, uncoated side edge regions of the adhesive element 20.

A plurality of arrangements of lines of perforations 60 provide a relatively effortless method for severing sections of any desirable length of tape from the roll. The arrangements of lines of perforations 60 are made before the adhesive tape device 10 is formed into a roll.

Any number of lines of perforations 60 can be used to create the arrangements of lines of perforations 60, and any shape and angle can be used. Also, any distance between each of the adjacent arrangements of lines of perforations 60 may be used.

As shown in FIGS. 1-4, each of the arrangements of lines of perforations 60 is set in, perpendicular to the length of each of the non-adhesive, impermanent discardable elements 50, adjacent and along each of the non-adhesive, impermanent discardable elements 50, across the entire width of the non-adhesive, impermanent discardable elements 50, including the partially affixed latitudinal ends 24 of the adhesive element 20, in which case each of the arrangements of lines of perforations 60 slightly overlap the latitudinal ends of the adhesive element 20. This slight overlap of lines of perforations 60 can be identified in FIG. 2, since the non-adhesive, impermanent discardable elements 50 are separated from the adhesive element 20. Since the arrangements of lines of perforations 60 only slightly overlap the latitudinal ends 24 of the adhesive element 20, this will allow the adhesive element 20 to remain intact until a desirable length of adhesive tape is peeled from the roll. Once a desirable length of adhesive tape is peeled from the roll, the adhesive tape 10 may be severed along one of the points where arrangements of lines of perforations are located.

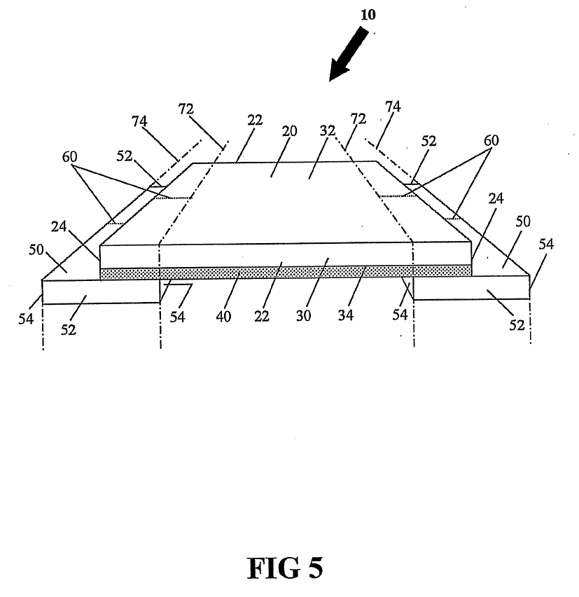

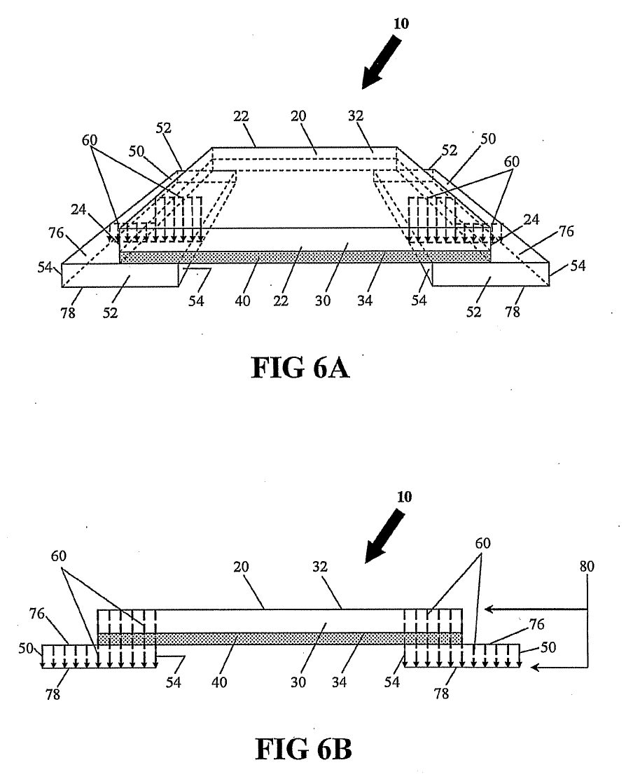

FIGS. 5, 6A, and 6B depict an inner boundary indication line 72 that delineates the boundary between each inner latitudinal edge 54 of the non-adhesive, impermanent discardable elements 50 and the latitudinal ends 24 of the adhesive element 20. Also depicted is an outer boundary indication line 74 that delineates the outer boundary of the outer latitudinal edge 54 of the non-adhesive, impermanent discardable elements 50. As can be seen in FIG. 5, lines of perforations 60 extend between the inner boundary indication line 72 and the outer boundary indication line 74.

As can be seen in FIGS. 6A and 6B, the perforations 60 may extend into the non-adhesive, impermanent, discardable element 50 and into the adhesive element 20. In other words, the perforations 60 may extend into a stack of layers 80 that comprise the outer portion of the adhesive element 20, the outer portion of the overlapping adhesive layer 40, and the inner portion of the non-adhesive, impermanent discardable elements 50. The perforations 60 do not extend the latitude of the adhesive element 20 of the adhesive tape device 10. By limiting the extent of the perforations 60 to the inner boundary indication line 72, the tensile stress required to tear the tape device 10 is increased such that inadvertent tears of the tape device 10 along perforations 60 do not occur. Rather, since the adhesive tape device 10 is not completely perforated it will require an amount of tensile force commensurate with an intentional tearing of the tape device 10 to completely tear the tape device 10.

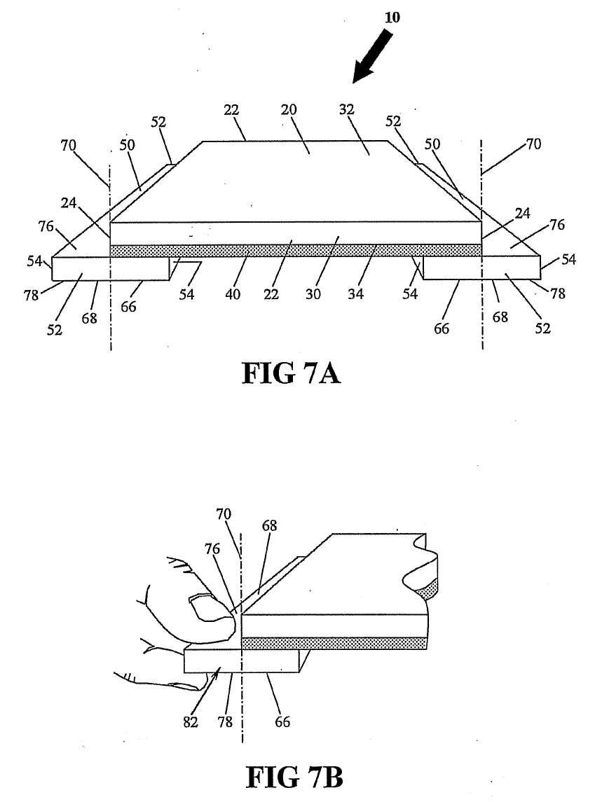

FIGS. 7A and 7B depict a division of regions indication line 70 on each latitudinal end 24 of the adhesive element 20. In this particular embodiment, the adhesive layer 40 spans the latitudinal ends 24. Moreover, an outside lateral end region 68 of the non-adhesive, impermanent discardable elements 50 extends outside the lateral ends 24 as shown by the division of regions indication lines 70. Accordingly, a first non-adhesive surface 76 (comprising only a portion of the upper area of the non-adhesive, impermanent discardable element 50) and a second non-adhesive surface 78 (comprising only a portion of the lower area of the non-adhesive, impermanent discardable element 50) form a singular pull-tab 82. The rest of the lower area of the non-adhesive, impermanent discardable element 50 may comprise a partially adhered region 66 that can partially adhere to an adjacent tape device 10.

In operation, the first non-adhesive surface 76 and the second non-adhesive surface 78 of the singular pull-tab 82 of the outside lateral end region 68 of the non-adhesive, impermanent, discardable element 50 can be compressively gripped by a user thereby allowing the singular pull-tab 82 to serve as a pull tab for the tape device 10. In other words, the user can pull the tape device 10 may gripping the non-adhesive surfaces 76, 78 of the singular pull-tab 82.

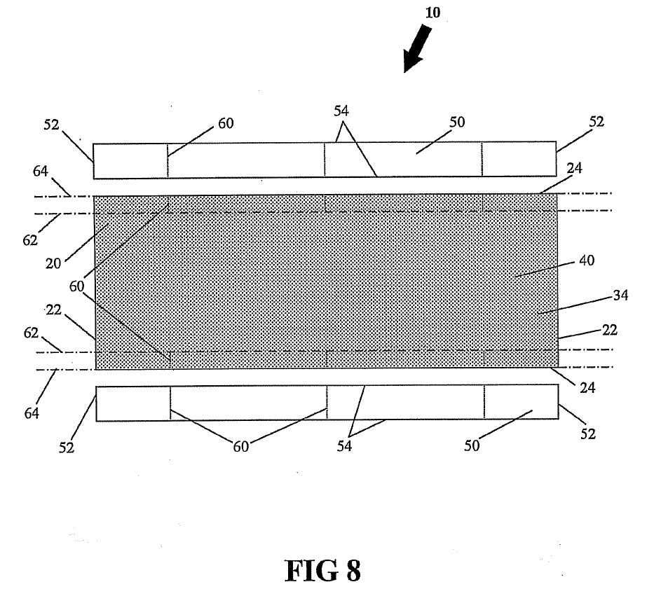

FIG. 8 depicts the tape device 10 with an adhering region inner boundary indication line 62 and an adhering region outer boundary indication line 64. Again, it can be seen from FIG. 8 that the adhesive layer 40 extends the lateral ends 24. Additionally, the adhesive layer 40 between the adhering region inner boundary indication line 62 and the adhering region outer boundary indication line 64 can remain intact when the non-adhesive, impermanent, discardable element 50 has been removed. If needed, the adhesive layer 40 between the adhering region inner boundary indication line 62 and the adhering region outer boundary indication line 64 can be coated with a releasable, non-stick agent such as, for example, waxes, lacquers, or other chemical solutions. Alternatively, a different adhesive coating other than the adhesive coating used between both adhering region inner boundar lines 64 may be used to allow for the non-adhesive, impermanent, discardable element 50 to be removed without damaging the underlying adhesive layer 40.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention. It is understood that various omissions and substitutions of equivalents are contemplated as circumstances may suggest or render expedient, but is intended to cover the application or implementation without departing from the spirit or scope of the claims of the present invention.

I claim:

1. An adhesive tape device comprising:
an adhesive element having a stack of layers with longitudinal and latitudinal ends; said stack includes at least a backing layer having a first side and a second side and an adhesive layer affixed thereupon said second side of said backing layer;
a non-adhesive, impermanent discardable element with longitudinal and latitudinal edges configuring a width and length thereof; said non-adhesive, impermanent discardable element affixed at least partially on said latitudinal ends of said second side of said backing layer of said adhesive element; and
a plurality of lines of perforations arranged across less than all of said width of said non-adhesive, impermanent discardable element and extending partially into said adhesive element across said latitudinal ends thereby configuring an easy tearable and peelable adhesive tape device thereof.

2. The adhesive tape device as claimed in claim 1 wherein said non-adhesive, impermanent discardable element extends beyond the latitudinal ends of the adhesive element.

3. The adhesive tape device as claimed in claim 1 wherein said adhesive tape device is able to be formed into a roll having a plurality of wraps with said adhesive layer of said adhesive element facing inward by rolling said adhesive tape device onto itself.

4. The adhesive tape device as claimed in claim 1 wherein said first and second side of said backing layer may be made up of any suitable materials including paper, plastic film, flatstock, or crepe.

5. The adhesive tape device as claimed in claim 1 wherein said backing layer may be compost-able, degradable, colored, printed material, embossed, and may be of different surface textures.

6. The adhesive tape device as claimed in claim 1 wherein said adhesive layer may be affixed to said second side of said backing layer in a multitude of various layouts and patterns.

7. The adhesive tape device as claimed in claim 6 wherein said second side of said backing layer may also include adhesive coating only along each said latitudinal and longitudinal ends of said second side of said backing layer.

8. The adhesive tape device as claimed in claim 6 wherein said second side of said backing layer may also include diagonal, horizontal, or criss-cross adhesive coated patterns on said second side of said backing layer.

9. The adhesive tape device as claimed in claim 6 wherein said adhesive for affixation of said adhesive layer to said second side of said backing layer may include hotmelt-coated formulations, transfer-coated formulations, solvent-coated formulations, latex formulations, or all pressure-sensitive adhesives.

10. The adhesive tape device as claimed in claim 6 wherein said adhesives may be based on general compositions of polyacrylate; polyvinyl ether; diene-containing rubber such as natural rubber, polyisoprene, and polyisobutylene; polychloroprene; butyl rubber; butadieneacrylonitrile polymer; thermoplastic elastomer; block copolymers such as styrene-isoprene and styrene-isoprene-styrene block copolymers, ethylene-propylene-diene polymers, and styrene-butadiene polymer; poly-alpha-olefin; amorphous polyolefin; silicone; ethylene-containing copolymer such as ethylene vinyl acetate, ethylacrylate, and ethyl methacrylate; polyurethane; polyamide; epoxy; polyvinylpyrrolidone and vinylpyrrolidone copolymers; polyesters; and mixtures of the above.

11. The adhesive tape device as claimed in claim 6 wherein said adhesives may also contain additives such as tackifiers, plasticizers, fillers, antioxidants, stabilizers, pigments, diffusing particles, curatives, and solvents.

12. The adhesive tape device as claimed in claim 5 wherein said printed material may be located either on said first side or on said second side of said backing layer before affixation of said adhesive layer and said printed material may include advertising, instructions, or other information.

13. The adhesive tape device as claimed in claim 1 wherein said adhesive element may also contain antistatic materials and said backing layer may be modified by flame treatment, corona treatment, and roughening.

14. The adhesive tape device as claimed in claim 1 wherein said non-adhesive, impermanent discardable element comprises polypropylene, polyethylene, copolymers of polypropylene and polyethylene, polymers, polyesters, and vinyl acetates.

15. The adhesive tape device as claimed in claim 1 wherein said non-adhesive, impermanent discardable element may be compost-able, degradable, colored, printed, embossed, and may be of different surface textures.

16. The adhesive tape device as claimed in claim 1 wherein said non-adhesive, impermanent discardable element may contain antistatic agents and may also be modified by flame treatment, corona treatment, and roughening.

17. The adhesive tape device as claimed in claim 1 wherein said non-adhesive, impermanent discardable element may be affixed onto said second surface of said adhesive layer using a releasable non-stick agent, waxes, lacquers, or other similar chemical solutions.

18. The adhesive tape device as claimed in claim 1 wherein said plurality of lines of apertures may be of any shape and angle, and any distance between each of the adjacent arrangements of apertures may be used.

19. An adhesive tape device comprising:
an adhesive element having a stack of layers with longitudinal and latitudinal ends; said stack includes at least a backing layer having a first side and a second side and an adhesive layer affixed thereupon said second side of said backing layer;
a non-adhesive, impermanent discardable element with longitudinal and latitudinal edges configuring a width and length thereof; said non-adhesive, impermanent discardable element affixed at least partially on said latitudinal ends of said second side of said backing layer of said adhesive element and extending beyond said latitudinal ends of said adhesive element; and
a plurality of lines of perforations arranged across said width of said non-adhesive, impermanent discardable element and extending partially into said adhesive element across said latitudinal ends thereby configuring an easy tearable and peelable adhesive tape device thereof.

20. The adhesive tape device as claimed in claim 19 wherein said plurality of lines of perforations are arranged across less than all of said width of said non-adhesive, impermanent discardable element.

21. The adhesive tape device as claimed in claim 19 wherein the portion of said non-adhesive, impermanent discardable element extending beyond said latitudinal ends of said adhesive element comprises a first and second non-adhesive surface which are operable to form a singular pull-tab.

22. The adhesive tape device as claimed in claim 19 wherein said non-adhesive, impermanent discardable element may be affixed onto said second surface of said adhesive layer using a releasable non-stick agent, waxes, lacquers, or other similar chemical solutions.

23. A method of easily peeling and tearing off sections of an adhesive tape device from a tape roll, the method comprising:
configuring an adhesive element having a stack of layers with longitudinal and latitudinal ends, said stack including at least a backing layer having a first side and a second side, and an adhesive layer affixed thereupon said second side of said backing layer;
configuring at least a non-adhesive, impermanent discardable element with longitudinal and latitudinal edges forming a width and length thereof, said non-adhesive, impermanent discardable element affixed at least partially on said latitudinal ends of said second side of said backing layer of said adhesive element;
configuring a plurality of lines of perforations arranged across said width of said non-adhesive, impermanent discardable element and extending partially into said adhesive element across said latitudinal ends;
holding the non-adhesive, impermanent discardable element and peeling off from the adhesive roll to a desired length;
tearing off the peeled adhesive tape at the lines of perforations, enabling an easy and effective tearing off of said adhesive tape device; and
peeling off said non-adhesive, impermanent discardable element and sticking to a desired surface.
